(19) United States
(12) Patent Application Publication
(10) Pub. No.: US 2004/0069157 A1
(43) Pub. Date: Apr. 15, 2004

(54) Microwaveable zipper bag

(76) Inventor: Irene H. Lin, Shanhua (TW)

Correspondence Address: Irene Lin, No. 71, Lane 53, Kuang-Hwa Rd., Shanhua, Tainan County, 741, TW

(21) Appl. No.: 10/273,860

(22) Filed: Oct. 15, 2002

(51) Int. Cl. A23L 3/26

(52) U.S. Cl. 99/451

(57) ABSTRACT

The present invention relates to a microwaveable zipper bag for food packaging. More particularly, it relates to a zipper bag with superior air and moisture vapor permeabilities, particularly suited for microwave heating of foods. The microwaveable zipper bag comprises a plurality of pseudo-closed gaps on the film for air permeation formed by virtue of an impression process and a pair of male-female zipper profile. An optional sealing layer material can be coated on the top of the film to fill the gaps. When the pressure difference across the film increases inside the closed microwaveable zipper bag, the heated air will inflate the bag. Those gaps will be opened gradually and regulates the pressure to prevent bursting of the microwaveable zipper bag. On the other hand, when the heating stops, the temperature inside the closed microwaveable zipper bag decreases and the sealing ability of the pseudo-closed gaps is restored due to a gap re-closing.

### BACKGROUND OF THE INVENTION

1. Field of the Invention

The present invention relates to a microwaveable zipper bag for food packaging. More particularly, it relates to a zipper bag with superior air and moisture vapor permeabilities, particularly suited for microwave heating of foods.

2. Description of the Related Art

Although microwave heating of food has existed already for more than 50 years; and almost all households in industrialized countries, own a domestic microwave oven, the main method for cooking is still one of the traditional methods: baking, boiling, steaming or frying.

Microwaveable containers and wrapping films are generally used as packaging materials for microwave heating. The structure of the same is made of a material or a combination of materials selected from the group consisting polyethylene (PE), polypropylene (PP) polycarbonate (PC), polyvinyl chloride(PVC), polyvinylidene chloride (PVDC), polymethylpentene(PMP), ethylene-vinyl acetate(EVA), Nylon, polyurethane (PU), polyethylene terephthalate (PET), ionomer, polyvinyl alcohol (PVA), etc.

In order to facilitate the fabrication of the above-mentioned packaging materials, the manufacturer may add certain plasticizer additives. The direct contact of these additives with the food product during storage, shipping and/or microwave heating may contaminate the food and have a negative impact on the health of the consumer.

Therefore, Public Health Administrators from many countries, including the Food and Drug Administration in USA, are setting strict requirements to regulate food packaging materials. In addition to the basic requirement that food products should not be contaminated by the packaging material, standards such as the resistance of the material to high and low temperatures have also been stipulated.

Due to increased consumer awareness and lifestyle changes, microwave heating and cooking has become increasingly popular and it is the goal of the Packaging Industry to develop a multi-purpose microwaveable packaging material that will meet the multiple requirements of the customer.

When microwave-heating a food product in an airtight packaging material, the rapid increase of temperature and vapor pressure may lead to the bursting of the packaging material. When this happens, the food will lose its water content quickly, and in turn the food will become hard and dry. In order to avoid bursting, many packaging supplier recommend piercing the packaging material before heating in the microwave oven to release the excess of pressure and hot steam. However, the piercing of the material will also allow volatile components to escape and as a result, the food will dry out and lose its wholesomeness.

Furthermore, foods such as bread, dumplings, spaghetti, etc. are usually heated in a steamer or in the microwave oven covered with wrapping film. When used properly, the steamer offers a tasty option, but the food could absorb too much water if the steamer is misused and it represents a very time-consuming choice. On the other hand, the use of wrapping film causes condensation of the steam on the food product, resulting in sogginess and if pierced, the food will dry out. Either case the organoleptic quality of the food will be greatly affected.

In order to avoid the bursting of packaging material during microwave heating, many research and development are in process. Although a wide variety of air and moisture vapor permeable materials have been developed for different purposes, such as waste water filtration, air filtration, diaper absorption mat, wet napkin, disposable packaging for medical goods, etc. However, none of these materials is suited as food packaging material for microwave heating.

In U.S. Pat. No. 5,928,582, for example, there is disclosed a method of forming a microporous membrane that uses a process of ultraviolet irradiation to form microsphereulites, followed by a thermally-induced phase separation, yielding microporous membranes that have improved flow and mechanical properties. In U.S. Pat. No. 5,865,926, Wu et al. disclose a method of making a cloth-like microporous laminate of a nonwoven fibrous web and thermoplastic film having air and moisture vapor permeability with liquid barrier properties.

Other manufacturing processes for production of relevant microporous films are known in U.S. Pat. Nos. 3,378,507; 3,310,505; 3,607,793; 3,812,224; 4,247,498 and 4,466,931. For example, in U.S. Pat. No. 4,350,655, Hoge teaches a process for manufacturing a highly porous thermoplastic film formed by cold drawing a film of a synthetic thermoplastic orientative polymer, such as high density polyethylene, and mixed with a coated inorganic filler. The highly porous thermoplastic film is produced by first casting a film of a blend of the polymer coated inorganic filler mixture, cooling the film to a temperature of 70° C. and cold stretching the film mono-axially or bi-axially to develop the desired void volume and surface ruptures per unit area, thereby obtaining a resin content (by weight) per cubic centimeter of final product of about 0.18 to about 0.32 gm/cc.

The coated inert inorganic filler and the molten polymer are blended together to form a homogeneous mixture in a suitable mixing extruder. The molten mixture is extruded through a die with an opening from 0.006 inches to 0.010 inches in size. The blend is cold stretched mono-axially or bi-axially, preferably in a station provided with a set of grooved rollers. The groove pattern of the rolls is generally of a sinosoidal wave pattern, wherein the film is stretched in a manner to affect uniform stretching between contact points of the material to produce a material of larger dimension in the stretching direction.

In U.S. Pat. No. 4,404,241, Mueller et al. disclose a method of making a microwave package with vent, which is a high cost multilayered sheet material. The multilayered material, such as PET, produced therefrom have circular apertures with ¼ inch to 1 inch of diameter. These apertures are then sealed with an extrudable hot melt material, such as wax. During microwave heating of food, the wax is molten and the apertures become an open space, from which the generated vapor is completely vented and the food can become hard and dry. It is also an irreversible structure, because after the heating process, the apertures stay open and cannot be resealed. Therefore, it poses the risk to microbial contamination.

Disadvantageously, however, the manufacturing processes of microporous film products according to the prior art methods are too complicated and too expensive to be generally accepted. Furthermore, many operating factors, such as temperature, stretching ratios, film thickness, starting materials etc., affect the microporous size of the final products, and thus resulting in variations of the quality of the microporous film products. In addition, the filler added to the microporous film products according to the prior art methods is a source of environmental pollution. Furthermore, most of the film products according to the prior art methods are opaque due to the multiple phases of the film products that result from the addition of fillers.

When food has, heretofore, been cooked at home, the food has been wrapped in a wrapping film for home use, or was packed and sealed in an air or moisture impermeable bag. This is heated in a microwave oven. Moisture contained in the food evaporates, and the bag is thus burst by internal vapor pressure. Moreover, when the film products according to the prior art methods are used to form a food packaging bag, some of the fillers may contaminate the food within the bag, which results in unpleasant odors. Another disadvantage of the film products according to the prior art methods is that they have poor resistance to alcohol and oil. Yet another disadvantage of the film products according to the prior art methods is that they are irreversible and cannot be reused.

### SUMMARY OF THE INVENTION

It is therefore a primary objective of this invention to provide a novel microwaveable zipper bag thereof to improve the prior art methods.

Another objective of the present invention is to provide a novel microwaveable zipper bag particularly adapted for use in general households. Thereof, to eliminate the possible spilling of food during microwave heating and reducing both the time spent and the water used for cleaning the microwave oven and also to provide an energy saving and cost effective choice for home defrosting, heating and cooking.

In accordance with the present invention, there is provided a microwaveable zipper bag comprising a polymer layer. The polymer layer has a plurality of gaps, which are structurally pseudo-closed when no pressure difference is applied to the polymer layer, and an attached pair of male-female zipper profile sealed with an ultrasonic sealing process, or a thermal sealing process so as to form a microwaveable zipper bag. Prior to microwave heating, the pair of male-female zipper profile must be sealed tightly to allow the rapid circulation of hot steam inside the bag, therefore reducing the heating time and increasing the energy efficiency.

Still another objective of this invention is to provide a reusable self-venting and automatic pressure regulating packaging material. As the temperature rises during the microwave heating, the packaging material self-vents to prevent microwaveable zipper bag from bursting. As the temperature decreases, after microwave heating stops, the packaging material reverses to its pseudo-closed structure and the venting capability is also restored. The reversible structure allows the microwaveable zipper bag to be reused if so the customer desires.

In accordance with the present invention, there is provided a microwaveable self-venting packaging material for packaging foods. The material used is 100% non-toxic and only water and carbon dioxide are produced after burning. This microwaveable self-venting packaging material can avoid both the direct contact of the same with food product during the microwave heating and the bursting resulting from pressure and temperature increase. This microwaveable self-venting packaging material can retain the nutritional value of the food as well as its organoleptic quality (taste and moisture). In addition, the flexible design of the packaging material can be custom designed to meet a wide range of temperature and other customer's requirements (any combination of sizes, thickness and materials).

In accordance with the present invention, there is provided a microwaveable zipper bag comprising a folded polymer layer with two overlapping sealed edges adjacent to the folded edge and one open end. The folded polymer layer has a plurality of gaps formed by virtue of an impression process. The open end is sealed with a pair of male-female zipper profile. Optionally, a sealing material can be coated on top of the gaps, as to form an airtight microwaveable zipper bag. Furthermore, the shape of the overlapping sealed edges can be a straight edge, a curved edge, a polygonal edge or a combination of the above.

The microwaveable zipper bag is suitable for microwave defrosting, heating and cooking in places such as households, restaurants, schools, airports, dormitories, etc. Frozen or refrigerated food is placed in the microwaveable zipper bag before being heated in the microwave oven. The pair of male-female zipper profile must seal tightly to form a closed packaging.

As the temperature rises, when the microwaveable zipper bag is subjected to a microwave oven, due to the vibration and abrasion of the molecules within the packaged food, the energy of microwave is converted to heat and the temperature and the vapor pressure inside the packaging bag also rises. When the differential pressure between the atmosphere and the inside of the packaging bag increases, the internal vapor pressure causes the microwaveable zipper bag to inflate, which enlarges the gaps. In addition, the optionally coated sealing material becomes molten because of the heat, and the sealing material becomes thinner and/or open up. Under these conditions the gaps become air and vapor permeable. The gaps in the present invention act as a pressure-regulating valve that prevents bursting of the microwaveable zipper bag.

In accordance with the present invention, there is provided a microwaveable zipper bag structure by first providing two polymer layers on which at least one of the two polymer layers comprises a plurality of gaps formed by virtue of an impression process. The two polymer layers are overlapped, and a sealing process seals three of the overlapping edges of the two polymer layers, leaving an open end in the microwaveable zipper bag. The open end of the bag is sealed using a pair of male-female zipper profile. Optionally, a sealing material can be coated on top of the gaps, as to form an airtight microwaveable zipper bag. Furthermore, the shape of the three overlapping sealed edges can be changed to a curved edge, a polygonal edge or a combination of the above.

These and other objectives of the present invention will no doubt become obvious to those of ordinary skill in the art after reading the following detailed description of the preferred embodiment, which is illustrated in the various figures and drawings.

### BRIEF DESCRIPTION OF THE DRAWINGS

FIG. 1A to FIG. 1C are cross-sectional diagrams of the structure of an air permeable film according to the present invention.

FIG. 2A to FIG. 2C are cross-sectional diagrams of the structure of an air permeable film after performing an impression process according to the present invention.

FIG. 3 is a top view of gaps on the surface of an air permeable film according to the present invention.

FIG. 4 is a cross-sectional diagram of the structure of an air permeable film having a sealing layer on the top face of the air permeable film according to the present invention.

FIG. 5 is a schematic diagram of a microwaveable zipper bag made from an air permeable film.

FIG. 6 is a schematic diagram of another embodiment of a microwaveable zipper bag made from an air permeable film.

### DETAILED DESCRIPTION OF THE PREFERRED EMBODIMENT

The microwaveable zipper bag comprises a plurality of pseudo-closed gaps on the polymer film for air permeation formed by virtue of an impression process and a pair of male-female zipper profile.

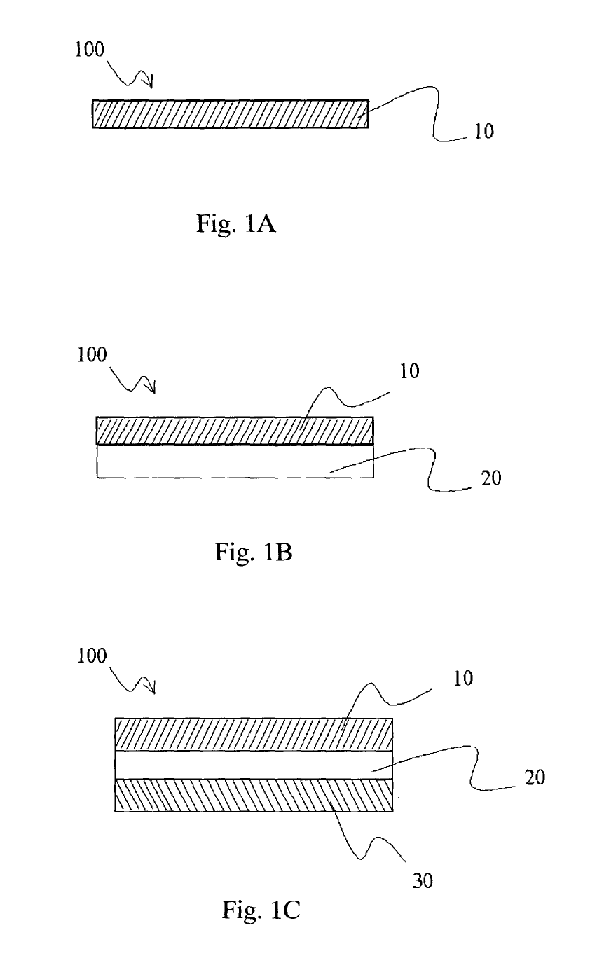

Please refer to FIG. 1A to FIG. 1C. FIG. 1A to FIG. 1C are cross-sectional diagrams of the structures of air permeable films before performing an impression process. As shown in FIG. 1A, a structure 100, in this embodiment a polymer layer is provided. The structure 100 is made of a material selected from a group comprising acrylic resins, polyester, polyethylene (PE), polypropylene (PP), copolymer of PE and PP, ethylene-styrene copolymer (ES), cyclo olefin, polyethylene terephthalate (PET), polyvinyl alcohol (PVA), ethylene-vinyl acetate (EVA), ionomer, polyethylene naphthalate (PEN), poly ether ether ketone (PEEK), polycarbonate (PC), polysulfone, polyimide (PI), polyacrylonitrile (PAN), styrene acrylonitrile (SAN), polyurethane (PU), or biodegradable material.

As shown in FIG. 1B, the structure 100 can be a stacked laminate including a first layer 10 and a second layer 20. The first layer 10 is made of a material selected from a group comprising acrylic resins, polyester, polyethylene (PE), polypropylene (PP), copolymer of PE and PP, ethylene-styrene copolymer (ES), cyclo olefin, polyethylene terephthalate (PET), polyvinyl alcohol (PVA), ethylene-vinyl acetate (EVA), ionomer, biodegradable material, polyethylene naphthalate (PEN), poly ether ether ketone (PEEK), polycarbonate (PC), polysulfone, polyimide (PI), polyacrylonitrile (PAN), styrene acrylonitrile (SAN), or polyurethane (PU). The second layer 20 is made of a material selected from a group comprising acrylic resins, polyester, polyethylene (PE), polypropylene (PP), ethylene-styrene copolymer (ES), cyclo olefin, polyethylene terephthalate (PET), polyvinyl alcohol (PVA), ethylene-vinyl acetate (EVA), ionomer, biodegradable material, polyethylene naphthalate (PEN), poly ether ether ketone (PEEK), polycarbonate (PC), polysulfone, polyimide (PI), polyacrylonitrile (PAN), styrene acrylonitrile (SAN), or polyurethane (PU), glassine papers, polyolefin coated paper, or polyester coated paper. For commercial purposes, the first layer 10 and the second layer 20 are preferably made of transparent materials.

As shown in FIG. 1C, the structure 100 can also be a sandwiched structure comprising a first layer 10, a second layer 20 stacked on the first layer 10, and a third layer 30 stacked on the second layer 20. The first layer 10 is made of a material with a relatively low melting point selected from a group comprising acrylic resins, polyester, polyethylene (PE), polypropylene (PP), copolymer of PE and PP, ethylene-styrene copolymer (ES), cyclo olefin, polyethylene terephthalate (PET), polyvinyl alcohol (PVA), ethylene-vinyl acetate (EVA), ionomer, biodegradable material, polyethylene naphthalate (PEN), poly ether ether ketone (PEEK), polycarbonate (PC), polysulfone, polyimide (PI), polyacrylonitrile (PAN), styrene acrylonitrile (SAN), or polyurethane (PU). The second layer 20 and the third layer 30 are made of materials selected from a group comprising acrylic resins, polyester, polyethylene (PE), polypropylene (PP), ethylene-styrene copolymer (ES), cyclo olefin, polyethylene terephthalate (PET), polyvinyl alcohol (PVA), ethylene-vinyl acetate (EVA), ionomer, biodegradable material, polyethylene naphthalate (PEN), poly ether ether ketone (PEEK), polycarbonate (PC), polysulfone, polyimide (PI), polyacrylonitrile (PAN), styrene acrylonitrile (SAN), or polyurethane (PU), glassine papers, polyolefin coated paper, or polyester coated paper.

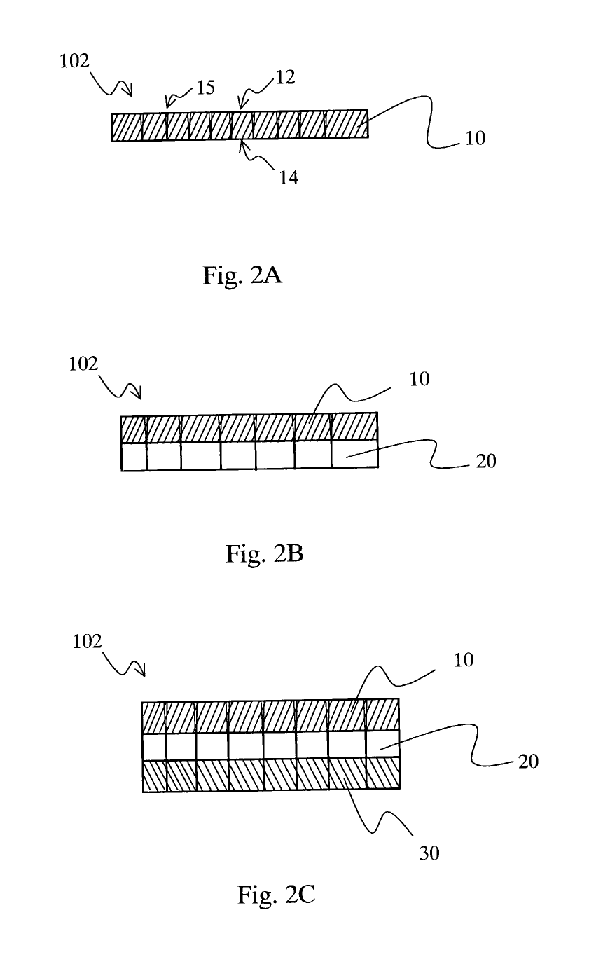

Please refer to FIG. 2A to FIG. 2C. FIG. 2A to FIG. 2C are cross-sectional diagrams of air permeable structures 102 after performing an impression process. These figures are in respective combination with FIGS. 1A to FIG. 1C. The structures 100 in FIG. 1A to FIG. 1C are partially or totally perforated by virtue of an impression process in a direction from the top face 12 to the bottom face 14, which forms a plurality of tiny gaps 15 on the structures 102 in FIG. 2A to FIG. 2C. After the impression process, the structures 100 in FIGS. 1A to 1C are permanently changed, forming the structures 102 in FIGS. 2A to 2C, respectively. When the structure 102 is in a static state, and without any external stress applied to it, the gaps 15 are approximately closed (pseudo-closed) and the surface of the structure 102 has a pseudo-planar topography with multiple phases. When the structure 102 swells due to external pressure, the gaps 15 enlarge.

The impressed area can be selected as desired to form a random impressed pattern, or the whole area can be impressed. Both continuous-type impression cylinder roller sets and batch-type planar table-like impression machines are suitable for the impression process. The former, however, is more economical, and is more easily automated. The continuous-type impression cylinder assembly comprises an impression cylinder and one opposing cylinder. Both the cylinder roller set and planar table-like machine include an impresser and a transfer co-impresser. At least one of the two impressers comprises a plurality of fine protruding grains on the surface of the cylinder or plate (not shown). The protruding grains may be formed using the following methods: (1) electroplating polyhedron diamond-like powders onto the surface of the impresser; (2) using a laser to engrave ceramic materials or metals formed on the surface of the impresser, such as anilox rolls; (3) using a mechanical tooling method and performing a surface hardening treatment, such as an annealing process, on the metal formed on the surface of the impresser, or plating a hard coating material on the surface of the impresser following a thermal treatment; (4) electrochemically etching and then performing a surface hardening treatment on the surface metal of the impresser. In addition, the opposing cylinder or plate, i.e. the co-impresser, should be made of a metal with a relatively high hardness, such as steel, or ceramic.

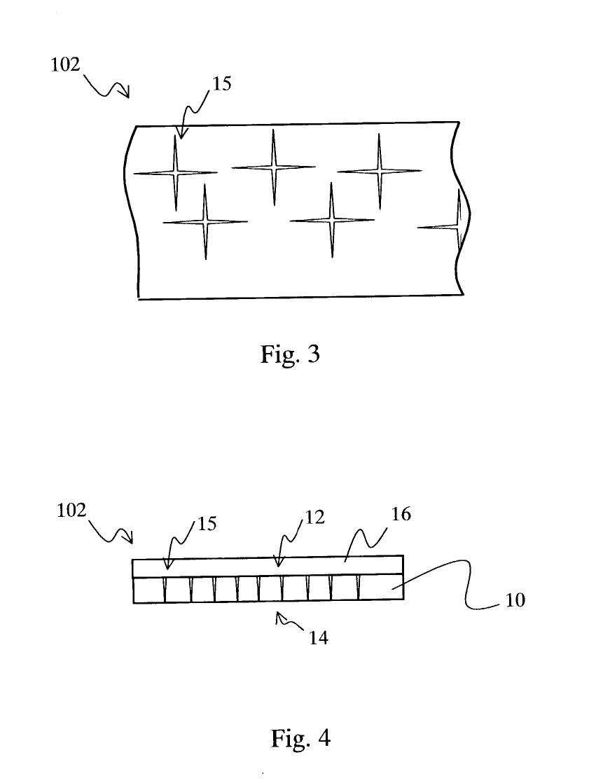

Please refer to FIG. 3. FIG. 3 depicts a top view of the gaps 15, with a cruciform shape, on the surface of the air permeable film structure 102 according to the present invention. It should be noted that the gaps 15 may have other shapes. Preferably, the shape of the gaps 15 are selected from groups consisting of linear shapes, conic shapes, pyramidal shapes, tetrahedral shapes, polygonal shapes, or cruciform shapes. Basically, the shape of the gaps 15 depends on the shape of the protruding grains on the surface of the cylinder or plate. The gaps 15 can be evenly distributed, locally distributed, regularly distributed, or irregularly distributed within the selected areas on the surface of the air permeable film structure 102, depending on the condition of the cylinders, sealing materials and the function of the air permeable film structure 102.

Please refer to FIG. 4. FIG. 4 is a cross-sectional diagram of the structure 102 in FIG. 2A with a sealing layer 16 on the top face 12 of the polymer layer 10. A sealing layer 16 can be optionally coated onto the top face 12 of the polymer layer 10. Similarly, the sealing layer 16 can also be coated onto the polymer layer 10 of FIG. 2B and FIG. 2C. The sealing layer 16 provides the structure 102 with waterproofing abilities, and better thermal insulating properties. The sealing layer 16 keeps the gaps 15 both sealed and air impermeable, and provides the structure 102 with water repelling abilities when the differential pressure between the top face 12 and bottom face 14 is approximately zero. When the differential pressure between the top face 12 and bottom face 14 becomes larger, the gaps 15 become air and vapor permeable. The sealing layer 16 may be coated by a sealing material prepared in an emulsion solution type, dispersion solution type, or a micronized powder type.

Preferably, the sealing layer 16 is made of a material selected from a group comprising lipids, oleaginous materials, wetting agents, surfactants, fatty acids and their derivatives, starch, or amyloid materials and their derivatives, palm waxes, paraffin waxes, micro-crystalline waxes, beeswax, rice bran waxes, synthetic polyethylene (PE) waxes, synthetic polypropylene (PP) waxes, synthetic polyethylene oxide (PEO) waxes and polyolefin. When the film structure 102 comes into contact with hot air, the heat of the hot air will degrade the sealing ability of the sealing layer 16, opening the pseudo-closed tiny gaps 15, and the hot air can easily permeate through the sealed gaps 15 of the polymer layer when the air pressure exerted by the hot air on the first side of the film is greater than the air pressure on the other side of the film structure 102. On the other hand, when the heating source is removed, the temperature of the film structure 102 decreases and the sealing layer 16 regains its sealing abilities. The sealing layer 16 used to fill the gaps 15 can be formed either before or after the impression process.

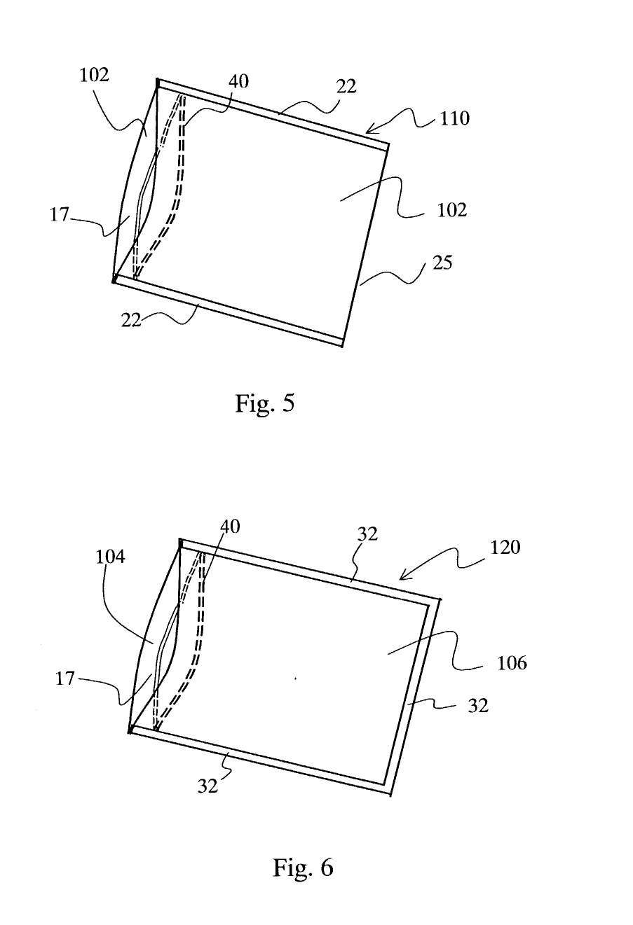

Please refer to FIG. 5. FIG. 5 is a schematic diagram of a microwaveable zipper bag 110 made of the structure 102 in FIG. 2A to FIG. 2C. It should be noted that the structure 102 of the microwaveable zipper bag 110 of the present invention can be made from any of the structures 102 shown in FIG. 2A to FIG. 2C. An air permeable structure 102, either from FIG. 2A, FIG. 2B, or FIG. 2C, is first provided. Optionally, a sealing material, as earlier mentioned, is coated on the surface of the structure 102 to improve the thermal insulation properties of the microwaveable zipper bag 110. The structure 102 is folded along the middle line 25 to superimpose the folded structure 102 upon itself. The two overlapping edges 22 are then sealed so as to form an open end 17. The two overlapping edges 22 can be sealed using an ultrasonic sealing process, or a thermal sealing process. The open end is sealed with a pair of male-female zipper profile by an ultrasonic sealing process or a thermal sealing process to form a microwaveable zipper bag 110.

Please refer to FIG. 6. FIG. 6 is a schematic diagram of another embodiment of a microwaveable zipper bag 120 made of the structure 102 in FIG. 2A to FIG. 2C. It should be noted that the structure 102 of the microwaveable zipper bag 120 of the present invention can be made from any of the structures 102 shown in FIG. 2A to FIG. 2C. An air permeable structure 102, either from FIG. 2A, FIG. 2B, or FIG. 2C, is first provided. Optionally, a sealing material, as earlier mentioned, is coated on the surface of the structure 102 to improve the thermal insulation properties of the microwaveable zipper bag 120. As shown in FIG. 6, the microwaveable zipper bag 120 is formed by superimposing a film 104 and a film 106, sealing three of the overlapping edges 32 to leave an open end 17. The three overlapping edges 32 can be sealed using an ultrasonic sealing process, or a thermal sealing process. The open end 17 sealed with a pair of male-female zipper profile by an ultrasonic sealing process or a thermal sealing process to form a microwaveable zipper bag 120.

After the food is packed into the microwaveable zipper bag 110 or 120, the open end 17 is sealed using a pair of male-female zipper profile. As seen in FIG. 5 and FIG. 6, in these embodiments, a zipper 40 consisting of a groove (female) and a rib (male)on each side of film 102 in FIG. 5, or on each film 104 and 106 in FIG. 6, is used to form an interlocking mechanism that can be conveniently opened and re-sealed by consumers. The pair of male-female zipper profile 40 is easily grasped. When the pair of male-female zipper profile 40 is pulled, the open end 17 of the microwaveable zipper bag 110 or 120 can be completely opened, and the contents easily removed from the microwaveable zipper bag 110 or 120.

The microwaveable zipper bag 110 or 120 of the present invention can be used in the packaging of a variety of foodstuffs, such as frozen and refrigerated food products, popcorn, or other substances. The foods packed within the microwaveable zipper bag, and which are to be defrosted, heated or cooked directly by means of radiation, such as microwave, infrared, etc. At the beginning of the microwave heating process, the packed food is under a low-temperature condition, and the vapor pressure inside the sealed microwaveable zipper bag is low. The gaps on the surface of the microwaveable zipper bag are thus pseudo-closed. At this stage, most of the microwave energy is kept in the microwaveable zipper bag and transferred to a state of heat that provides a uniform heating effect on the food. As the temperature rises, the vapor pressure inside the sealed microwaveable zipper bag also rises. When the differential pressure between the atmosphere and the inside of the microwaveable zipper bag increases, the internal vapor pressure inflates the microwaveable zipper bag and thus enlarges the gaps. When the temperature reaches the softening point of the sealing material, the sealing layer becomes malleable because of the heat, and the thickness of the sealing layer begins to lessen and/or the gaps may start opening up. That makes the gaps become air and/or vapor permeable. The gaps in the present invention act as a pressure-regulating valve that prevents the breakage or bursting of the microwaveable zipper bag due to the buildup of hot air and steam during a microwave heating process.

It is advantageous to use the microwaveable zipper bag of the present invention because the final condition of the food can be finely controlled by using different recipes in combination with the number of gaps, shape of the gaps, density of the gaps, distribution of the gaps, film thickness of the microwaveable zipper bag, starting material of the microwaveable zipper bag, and the material used in the sealing layer. In addition, cooked food packed in the sealed microwaveable zipper bag can be frozen or heated repeatedly without impairing the taste of the food, as the structure of the microwaveable zipper bag can be restored to its original pseudo-closed condition.

One of the main features of the invention is that the microwaveable zipper bag 110 and 120 can be used for comestible articles that are to be cooked in a microwave oven with a uniform cooking result. It also prevents the excessive loss of food constituents, such as water, alcohol, fat, flavor, aromatics and other special components. It provides a means for reducing the criticality of the microwave cooking time, as well as reducing the attention and activity associated with conventional microwave cooking. More particularly, the present invention enables the cooking of frozen foods in microwave ovens without having to initially thaw the food, and/or without having to provide power level changes to sequentially effect thawing and cooking. The microwaveable zipper bag 110 and 120 of this invention can be refrigerated or frozen during the storage of the contained product, and functions very effectively under such conditions. Also, the microwaveable zipper bag 110 and 120 of this invention provides a low-cost, self-identifying microwave-cooking container that may also be used for leftovers and home-frozen foods. Furthermore, the microwaveable zipper bag 110 and 120 of this invention can be used for microwave sterilization of microwaveable utensils or medical goods

Most importantly, the microwaveable zipper bag 110 and 120 can be made almost fully transparent. And as previously explained, the microwaveable zipper bag 110 and 120 is re-usable, and may be used repeatedly for leftovers, for freezing or refrigeration, or for general storage, for sterilization, and subsequent re-heating within a microwave oven.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A microwaveable zipper bag, comprising:
a first polymer film, the polymer film comprising a plurality of pseudo-closed gaps for air permeation formed by virtue of an impression process;
a second polymer film stacking to the first polymer film and overlapping the edges, then performing a sealing process to seal the overlapping edges of the first polymer film and second polymer film so as to form a bag structure with a bag opening end; and
a pair of male-female zipper profile is thermally sealed to the inner surface of the bag opening end,
wherein the foodstuff is packed within the microwaveable zipper bag, and said microwaveable zipper bag is tightly closed with the pair of male-female zipper profile prior to microwave heating, then heated by means of radiation, when the air pressure exerted by the hot air inside the closed microwaveable zipper bag is greater than the air pressure outside the closed microwaveable zipper bag, the heated air will inflate the bag, and open up the pseudo-closed tiny gaps gradually, and the hot air can easily permeate through the pressure deformed and enlarged pseudo-closed gaps of the polymer film of the microwaveable zipper bag; on the other hand, when the heating source is removed, the temperature inside the closed microwaveable zipper bag decreases and the sealing ability of the pseudo-closed gaps is gradually restored when cooled; the self-venting ability is reversibly functional of pressure difference.

2. A microwaveable zipper bag of claim 1, wherein the first polymer film is made by one of the following materials: acrylic resins, polyester, polyethylene (PE), polypropylene (PP), copolymer of PE and PP, ethylene-styrene copolymer (ES), cyclo olefin, polyethylene terephthalate (PET), Nylon, polyvinyl alcohol (PVA), ethylene-vinyl acetate (EVA), ionomer, biodegradable material, polyethylene naphthalate (PEN), poly ether ether ketone (PEEK), polycarbonate (PC), polysulfone, polyimide (PI), polyacrylonitrile (PAN), styrene acrylonitrile (SAN), polyurethane (PU), glassine papers, polyolefin coated paper, polyester coated paper or combination of above materials.

3. A microwaveable zipper bag of claim 1, wherein the first polymer film contains one or more polymer layers on one side of the first polymer film, each made by one of the following materials: acrylic resins, polyester, polyethylene (PE), polypropylene (PP), copolymer of PE and PP, ethylene-styrene copolymer (ES), cyclo olefin, polyethylene terephthalate (PET), Nylon, polyvinyl alcohol (PVA), ethylene-vinyl acetate (EVA), ionomer, biodegradable material, polyethylene naphthalate (PEN), poly ether ether ketone (PEEK), polycarbonate (PC), polysulfone, polyimide (PI), polyacrylonitrile (PAN), styrene acrylonitrile (SAN), polyurethane (PU), glassine papers, polyolefin coated paper, polyester coated paper or combination of above materials.

4. A microwaveable zipper bag of claim 3, wherein the first polymer film further contains one polymer layer, which is the outmost polymer layer, this outmost polymer layer is made by a heat sealable material with a lower melting temperature as compared with the first polymer film.

5. A microwaveable zipper bag of claim 1, wherein the surface of the polymer film can further comprise a sealing layer for filling the gaps to prevent air permeation.

6. A microwaveable zipper bag of claim 5, wherein the sealing layer is made from fatty acids or their derivatives, starch, amyloid materials or their derivatives, lipids, oleaginous materials, gelatins, wetting agents, or waxes.

7. A microwaveable zipper bag of claim 6, wherein the waxes are natural waxes or synthetic waxes.

8. A microwaveable zipper bag, comprising:
a polymer film, the polymer film comprising a plurality of pseudo-closed gaps for air permeation formed by virtue of an impression process, the polymer film comprising a first part and a second part;
a folding of the polymer film to overlap the first part against the second part then performing a sealing process to seal the overlapping edges of the first part and the second part, so as to form a bag structure with a opening end; and
a pair of male-female zipper profile is thermally sealed to the inner surface of the bag opening end,
wherein the foodstuff is packed within the microwaveable zipper bag, and said microwaveable zipper bag is tightly closed with the pair of male-female zipper profile prior to microwave heating, then heated by means of radiation, when the air pressure exerted by the hot air inside the closed microwaveable zipper bag is greater than the air pressure outside the closed microwaveable zipper bag, the heated air will inflate the bag, and open up the pseudo-closed tiny gaps gradually, and the hot air can easily permeate through the pressure deformed and enlarged pseudo-closed gaps of the polymer film of the microwaveable zipper bag; on the other hand, when the heating source is removed, the temperature inside the closed microwaveable zipper bag decreases and the sealing ability of the pseudo-closed gaps is gradually restored when cooled; the self-venting ability is reversibly functional of pressure difference.

9. A microwaveable zipper bag of claim 8, wherein the polymer film is made by one of the following materials: acrylic resins, polyester, polyethylene (PE), polypropylene (PP), copolymer of PE and PP, ethylene-styrene copolymer (ES), cyclo olefin, polyethylene terephthalate (PET), Nylon, polyvinyl alcohol (PVA), ethylene-vinyl acetate (EVA), ionomer, biodegradable material, polyethylene naphthalate (PEN), poly ether ether ketone (PEEK), polycarbonate (PC), polysulfone, polyimide (PI), polyacrylonitrile (PAN), styrene acrylonitrile (SAN), polyurethane (PU), glassine papers, polyolefin coated paper, polyester coated paper or combination of above materials.

10. A microwaveable zipper bag of claim 8, wherein the polymer film further comprises one or more polymer layers on one side of the polymer film, each made by one of the following materials: acrylic resins, polyester, polyethylene (PE), polypropylene (PP), copolymer of PE and PP, ethylene-styrene copolymer (ES), cyclo olefin, polyethylene terephthalate (PET), Nylon, polyvinyl alcohol (PVA), ethylene-vinyl acetate (EVA), ionomer, biodegradable material, polyethylene naphthalate (PEN), poly ether ether ketone (PEEK), polycarbonate (PC), polysulfone, polyimide (PI), polyacrylonitrile (PAN), styrene acrylonitrile (SAN), polyurethane (PU), glassine papers, polyolefin coated paper, polyester coated paper or combination of above materials.

11. A microwaveable zipper bag of claim 8, wherein the polymer film further contains one polymer layer which is the outmost polymer layer, this outmost polymer layer is made by a heat sealable material with a lower melting temperature as compared with the polymer film.

12. A microwaveable zipper bag of claim 8, wherein the surface of the polymer film can further comprise a sealing layer for filling the gaps to prevent air permeation.

13. A microwaveable zipper bag of claim 12, wherein the sealing layer is made from fatty acids or their derivatives, starch, amyloid materials or their derivatives, lipids, oleaginous materials, gelatins, wetting agents, or waxes.

14. A microwaveable zipper bag of claim 13, wherein the waxes are natural waxes or synthetic waxes.
